(19) United States
(12) Patent Application Publication
(10) Pub. No.: US 2023/0385806 A1
(43) Pub. Date: Nov. 30, 2023

(54) METHODS AND SYSTEMS FOR TEMPORARY VOUCHER SHARING

(71) Applicant: FAVORDROP, INC., Williamsville, NY (US)

(72) Inventor: Timothy Sardinia, Williamsville, NY (US)

(21) Appl. No.: 18/248,247

(22) PCT Filed: Oct. 8, 2021
(86) PCT No.: PCT/US2021/054187

§ 371 Date: Apr. 7, 2023

Related U.S. Application Data
(60) Provisional application No. 63/089,581, filed on Oct. 9, 2020.

(51) Int. Cl. G06Q 20/34; G06Q 20/28; G06Q 20/40; G06Q 20/02

(52) U.S. Cl. CPC G06Q 20/342; G06Q 20/28; G06Q 20/401; G06Q 20/02

(57) ABSTRACT

A system and method of temporary voucher sharing are provided. The method includes receiving, from a user device associated with a user, at a processor of an administrator device, a favordrop request created at the user device. The favordrop request includes a beneficiary identifier associated with a beneficiary, a request value, a retailer location, and an expiration time. The method further includes defining, using the processor, a favordrop comprising a balance corresponding to the request value; assigning, using the processor, the favordrop to the beneficiary; and sending, using the processor, a notification to a beneficiary device associated with the beneficiary identifier, the notification comprising notification data. The notification data is at least partially display able on a display screen of the beneficiary device. When a current time reaches the expiration time, the processor is configured to revoke the favordrop from the beneficiary and send a return notification to the user device.

### CROSS-REFERENCE TO RELATED APPLICATIONS

The disclosure claims priority to U.S. Provisional Application No. 63/089,581, filed Oct. 9, 2020, the entire disclosure of which is incorporated by reference herein.

### FIELD OF THE DISCLOSURE

The disclosure generally relates to temporary voucher sharing.

### BACKGROUND OF THE DISCLOSURE

Gift cards or vouchers may be purchased by buyers and given as gifts. Gift cards carry a value redeemable at a given retailer (or other institution). In some instances, the retailer may be the issuing organization, in others, institutions may band together to issue gift cards, and in even others, a third-party may issue the gift cards.

In some instances, a gift card may have a time printed on it by which the balance of the gift card must be redeemed or the card “expires,” and thus any remaining balance is no longer redeemable at the retailer. In some instances, there may be state law governing gift cards and the disposal of their value upon final expiration. In these examples, the buyer of the gift card may not know if any or all of the gift card's balance was redeemed at the retailer by the beneficiary or not. Furthermore, if the beneficiary does not redeem the full balance of the gift card by the expiration time, the full value of the gift from the buyer to the beneficiary cannot be realized by the beneficiary and/or the buyer.

Thus, a problem exists with respect to the expiration of gift cards and lost value sometimes known to the beneficiary and often unknown to the buyer.

Therefore, improvements and new ways of value-sharing are needed.

### BRIEF SUMMARY OF THE DISCLOSURE

An embodiment of the present disclosure provides a method of temporary voucher sharing. The method may comprise receiving, from a user device associated with a user, at a processor of an administrator device, a favordrop request created at the user device. The favordrop request may include a beneficiary identifier associated with a beneficiary, a request value, a retailer location, and an expiration time. The method may further comprise defining, using the processor, a favordrop comprising a balance corresponding to the request value. The method may further comprise assigning, using the processor, the favordrop to the beneficiary. The method may further comprise sending, using the processor, a notification to a beneficiary device associated with the beneficiary identifier, the notification comprising notification data. The notification data may be at least partially displayable on a display screen of the beneficiary device. When a current time reaches the expiration time, the processor may be configured to revoke the favordrop from the beneficiary and send a return notification to the user device.

According to an embodiment of the present disclosure, the user may be a merchant, and the user device may be a merchant device associated with the retailer location. When the current time reaches the expiration time, the processor may be further configured to apply the balance of the favordrop to an account balance of the merchant.

According to an embodiment of the present disclosure, the method may further comprise verifying, using the processor, that a payment transaction for the request value has successfully completed using a payment request initiated by the user device and thereafter defining the balance as being equal to the request value. When the current time reaches the expiration time, the processor may be further configured to assign the favordrop to the user; The notification data may be at least partially displayable on a display screen of the user device and the return notification may comprise the notification data.

According to an embodiment of the present disclosure, verifying that the payment transaction for the request value has successfully completed may comprise receiving a confirmation from a third-party payment processor indicating that the payment transaction has successfully completed.

According to an embodiment of the present disclosure, the method may further comprise creating, using a job scheduler executed by the processor, an expiration job in a job queue managed by the job scheduler. The expiration job may comprise one or more instructions, executable by the processor, to revoke the favordrop from the beneficiary. The job scheduler may be configured to instruct the processor to execute the one or more instructions of the expiration job after the job scheduler determines that the current time reaches the expiration time, thereby revoking the favordrop from the beneficiary when the current time reaches the expiration time.

According to an embodiment of the present disclosure, the method may further comprise receiving, from a retailer device associated with the retailer location, at the processor, a redemption notification that the favordrop was applied as a payment for a purchase at the retailer location. The method may further comprise updating, using the processor, the balance based on a portion of the favordrop applied as the payment for the purchase at the retailer location.

According to an embodiment of the present disclosure, the notification data may comprise a code, which, when input by a retailer device associated with the retailer location, may apply the balance of the favordrop as a payment for a purchase at the retailer location. The code may comprise a quick-response code, a numerical code, or an alpha-numerical code.

According to an embodiment of the present disclosure, the notification data may comprise the balance and the expiration time.

Another embodiment of the present disclosure provides a system for temporary voucher sharing. The system may comprise an administrator device having a processor. The processor may be configured to receive, from a user device associated with a user, a favordrop request created at the user device. The favordrop request may include a beneficiary identifier associated with a beneficiary, a request value, a retailer location, and an expiration time. The processor may be further configured to define a favordrop comprising a balance corresponding to the request value. The processor may be further configured to assign the favordrop to the beneficiary. The processor may be further configured to send a notification to a beneficiary device associated with the beneficiary identifier. The notification may comprise notification data, and the notification data may be at least partially displayable on a display screen of the beneficiary device. When a current time reaches the expiration time, the processor may be further configured to revoke the favordrop from the beneficiary and send a return notification to the user device.

According to an embodiment of the present disclosure, the user may be a merchant, and the user device is a merchant device associated with the retailer location. When the current time reaches the expiration time, the processor may be further configured to apply the balance of the favordrop to an account balance of the merchant.

According to an embodiment of the present disclosure, the processor may be further configured to verify that a payment transaction for the request value has successfully completed using a payment request initiated by the user device and thereafter defining the balance as being equal to the request value. When the current time reaches the expiration time, the processor may be further configured to assign the favordrop to the user. The notification data may be at least partially displayable on a display screen of the user device and the return notification may comprise the notification data.

According to an embodiment of the present disclosure, the processor may be configured to verify that the payment transaction for the request value has successfully completed by receiving a confirmation from a third-party payment processor indicating that the payment transaction has successfully completed.

According to an embodiment of the present disclosure, the processor may be further configured to create, using a job scheduler executed by the processor, an expiration job in a job queue managed by the job scheduler. The expiration job may comprises one or more instructions, executable by the processor, to revoke the favordrop from the user. The job scheduler may be configured to instruct the processor to execute the one or more instructions of the expiration job after the job scheduler determines that the current time reaches the expiration time, thereby revoking the favordrop from the beneficiary when the current time reaches the expiration time.

According to an embodiment of the present disclosure, the processor may be further configured to receive, from a retailer device associated with the retailer location, a redemption notification that the favordrop was applied as a payment for a purchase at the retailer location. The processor may be further configured to update the balance based on a portion of the favordrop applied as the payment for the purchase at the retailer location.

According to an embodiment of the present disclosure, the notification data may comprise a code, which, when input by a retailer device associated with the retailer location, may apply the balance of the favordrop as a payment for a purchase at the retailer location. The code may comprise a quick-response code, a numerical code, or an alpha-numerical code.

According to an embodiment of the present disclosure, the notification data may comprise the balance and the expiration time.

Another embodiment of the present disclosure provides a tangible, non-transient, computer-readable media having instructions thereupon which, when implemented by a processor, causes the processor to perform a method of temporary voucher sharing. The method may comprise receiving, from a user device associated with a user, at the processor, a favordrop request created at the user device. The favordrop request may include a beneficiary identifier associated with a beneficiary, a request value, a retailer location, and an expiration time. The method may further comprise defining a favordrop comprising a balance corresponding to the request value. The method may further comprise assigning the favordrop to the beneficiary. The method may further comprise sending a notification to a beneficiary device associated with the beneficiary identifier. The notification may comprise notification data. The notification data may be at least partially displayable on a display screen of the beneficiary device. When a current time reaches the expiration time, the processor may be configured to revoke the favordrop from the beneficiary and send a return notification to the user device.

According to an embodiment of the present disclosure, the user may be a merchant, and the user device may be a merchant device associated with the retailer location. When the current time reaches the expiration time, the processor may be further configured to apply the balance of the favordrop to an account balance of the merchant.

According to an embodiment of the present disclosure, the method may further comprise verifying, using the processor, that a payment transaction for the request value has successfully completed using a payment request initiated by the user device and thereafter defining the balance as being equal to the request value. When the current time reaches the expiration time, the processor may be further configured to assign the favordrop to the user; The notification data may be at least partially displayable on a display screen of the user device and the return notification may comprise the notification data.

According to an embodiment of the present disclosure, verifying that the payment transaction for the request value has successfully completed may comprise receiving a confirmation from a third-party payment processor indicating that the payment transaction has successfully completed.

According to an embodiment of the present disclosure, the method may further comprise creating, using a job scheduler executed by the processor, an expiration job in a job queue managed by the job scheduler. The expiration job may comprise one or more instructions, executable by the processor, to revoke the favordrop from the beneficiary. The job scheduler may be configured to instruct the processor to execute the one or more instructions of the expiration job after the job scheduler determines that the current time reaches the expiration time, thereby revoking the favordrop from the beneficiary when the current time reaches the expiration time.

According to an embodiment of the present disclosure, the method may further comprise receiving, from a retailer device associated with the retailer location, at the processor, a redemption notification that the favordrop was applied as a payment for a purchase at the retailer location. The method may further comprise updating, using the processor, the balance based on a portion of the favordrop applied as the payment for the purchase at the retailer location.

According to an embodiment of the present disclosure, the notification data may comprise a code, which, when input by a retailer device associated with the retailer location, may apply the balance of the favordrop as a payment for a purchase at the retailer location. The code may comprise a quick-response code, a numerical code, or an alpha-numerical code.

According to an embodiment of the present disclosure, the notification data may comprise the balance and the expiration time.

### BRIEF DESCRIPTION OF THE FIGURES

For a fuller understanding of the nature and objects of the disclosure, reference should be made to the following detailed description taken in conjunction with the accompanying drawings, in which:

FIG. 1 illustrates a method of temporary voucher sharing according to an embodiment of the present disclosure;

FIG. 2A illustrates an example favordrop request according to an embodiment of the present disclosure;

FIG. 2B illustrates an example favordrop according to an embodiment of the present disclosure;

FIG. 3 illustrates an example job queue according to an embodiment of the present disclosure;

FIG. 4 illustrates an example temporary voucher sharing system according to an embodiment of the present disclosure;

FIG. 5 illustrates an example payment processing system according to an embodiment of the present disclosure;

FIG. 6 illustrates a temporary voucher sharing apparatus according to an embodiment of the present disclosure;

FIGS. 7A-7E illustrate an example buyer user interface according to an embodiment of the present disclosure;

FIGS. 8A-8C illustrate an example beneficiary user interface according to an embodiment of the present disclosure; and

FIGS. 9A-9C illustrate an example flowchart according to an embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Embodiments of the present disclosure may be utilized in conjunction with standard hardware peripherals, which while may not be illustrated herein may be inferred, including, for example, CPUs, memory, keyboards, mice, touchscreens, networking devices and hardware, buttons, and sensors. Software functionality disclosed herein can be implemented in hardware and, in any event, is embodied in physical storage devices (memory) including non-transitory computer-readable storage media. Software functionality disclosed herein may further be implemented on or across one or more physical devices.

In particular, devices described herein can run server, desktop, laptop and other portable device operating systems such as, for example, Unix, Linux, Windows, Mac OS, iOS, Android, etc.

Embodiments disclosed herein include methods, systems, and apparatuses for temporary voucher sharing. Such temporary vouchers may be referred to as favordrops herein and may be similar to aspects of, for example, loyalties, awards, rewards, gifts, promotionals, certificates, invitations, etc.

In an instance, a user (e.g., a sender of a favordrop) may share a favordrop with a beneficiary (e.g., a receiver of a favordrop) for a time (e.g., a time period ending at, for example an expiration (e.g., withdraw, return, revoke, ending, reversion, reappropriate, reassign, claw back) time) that is either predetermined or determined by, for example, the user. In this way, the user may share the favordrop with the beneficiary, thus providing the beneficiary with temporary access or utilization to all or a part of a balance of the favordrop. During this time, the user may be prevented from accessing or utilizing the all or a part of the balance of the favordrop. At the conclusion of the time, the beneficiary may be no longer able to access or utilize all or a part of the balance of the favordrop. At the conclusion of the time, the user may again be able to access or utilize all or a part of the balance of the favordrop, or again share it with the beneficiary or another beneficiary.

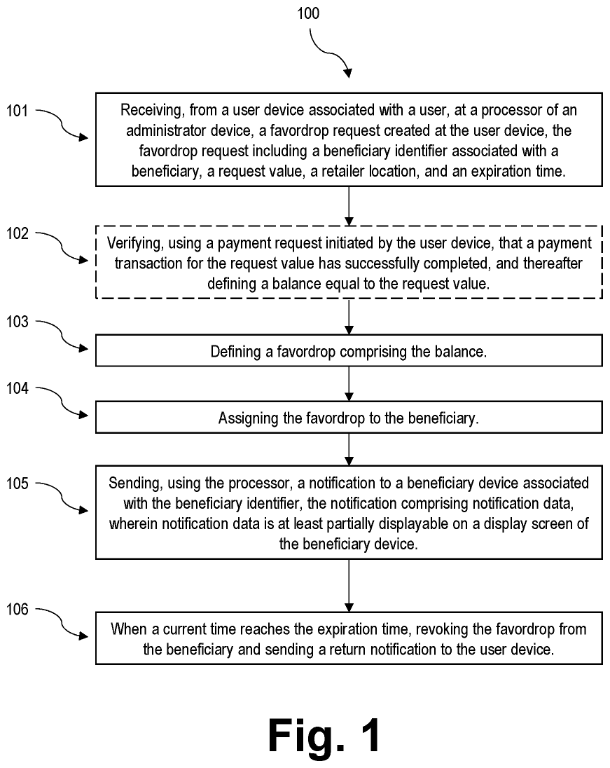

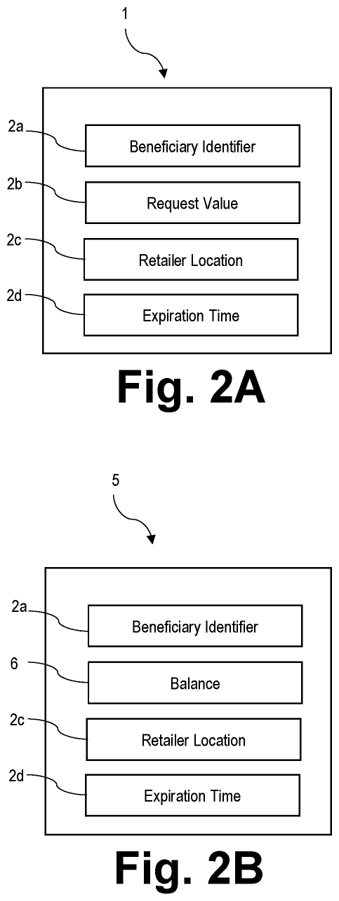

In an instance, an embodiment of the present disclosure may provide a method 100, as illustrated, for example, with reference to FIG. 1, FIG. 2A, and FIG. 2B. Method 100 may comprise, at 101, receiving, from a user device associated with a user, at a processor of an administrator device, a favordrop request, for example, favordrop request 1, created at the user device. Favordrop request 1 may include a beneficiary identifier 2a associated with a beneficiary, a request value 2b, a retailer location 2c, and an expiration time 2d. Favordrop request 1 may be a data structure as depicted in FIG. 2A. Favordrop request 1 may be sent to the processor of the administrator device by a suitable means, for example, via the Internet or a cellular network. The processor of the administrator device may receive favordrop request 1 via a network interface of the administrator device, which may be, for example, a network interface.

According to some embodiments of the present disclosure, the user may be an individual. Thus, 101 may be performed at a user device associated the individual. In such a scenario, the user may be a buyer of the favordrop 1, which can be sent to a beneficiary (e.g., another user/individual) to access or utilize all or part of the balance of the favordrop 1.

According to some embodiments of the present disclosure, the user may be a merchant. Thus, 101 may be performed at a user device associated with the merchant. In such a scenario, the merchant may sent the favordrop 1 to a beneficiary to access or utilize all or part of the balance of the favordrop 1 at a retailer location associated with the merchant.

When the user is an individual, the method 100 may further comprise, at 102, verifying a payment transaction using a payment request initiated by the buyer device. For example, the payment request may verify that the payment transaction for the request value 2b has successfully completed. If the payment transaction is successful, a balance 6 may be defined. The balance 6 may be less than or equal to the request value 2b. For example, if the payment transaction carries a processing fee, the balance 6 may be less than the request value. Alternatively, the processing fee may be added to the request value in the payment transaction, such that the balance 6 may be equal to the request value.

In some embodiments, the payment transaction may occur using a third-party payment processor. In such embodiments, the user may submit certain information including transaction information (e.g., credit card or virtual payment information) to a third-party payment processor for the execution of a payment transaction valued at the request value (such a value may include any transaction fees). The third-party payment processor may attempt to execute a payment transaction for the request value and send a payment transaction status to the user device, the administrator device, or both. The payment transaction status may include information regarding the success or failure of the attempted payment transaction. For example, if a payment transaction succeeds, in some embodiments the third-party payment processor may provide a status to the processor of the administrator device, verifying that the payment transaction successfully completed. In another example, in some embodiments the third-party payment processor may provide a status to the user device, which may be, for example, tokenized or encrypted, which the user device may then pass to the processor of the administrator device. In these examples, the processor of the administrator device can verify the payment transaction by determining whether the received status of the payment transaction includes an indication that the payment transaction has successfully completed.

In some embodiments, the payment transaction may be performed by the administrator, for example using the administrator device. In such embodiments, administrator device may receive certain information including transaction information (e.g., credit card or virtual payment information) for execution of a payment transaction valued at the request value. The administrator device may attempt to execute a payment transaction for the request value, and whether the payment transaction succeeds or fails may provide verification to the processor. For example, the processor of the administrator device can verify the payment transaction by determining whether the attempted payment transaction succeeded or failed.

When user is a merchant, it may not be necessary to verify a payment transaction at 102 if the merchant is associated with the retailer location 2c provided in the favordrop request 1. In such a scenario, balance 6 may be defined as being equal to the request value 2b.

Method 100 may further comprise, at 103, defining, using the processor, a favordrop 5. Favordrop 5 may comprise balance 6. Favordrop 5 may also comprise beneficiary identifier 2a, retailer location 2c, and expiration time 2d. The favordrop 5 may be redeemable only at the retailer location 2c, or may be redeemable at other locations related to the retailer location 2c. The expiration time 2d may be defined by the user using the user device. For example, the user may select a user-defined time as the expiration time 2d. Alternatively, the expiration time 2d may be defined by the administrator device. For example, the administrator device may set a default time or a plurality of default times as the expiration time 2d. In yet another alternative, the expiration time 2d may be defined by a retailer associated with the retailer location 2c. For example, the retailer may set its own time for redemption of the balance 6 of the favordrop 5 at its institution. The expiration time 2d may correspond to a particular date and time (e.g., December 31^{st} at 11:59 PM, etc.), or a particular period of time (e.g., 24 hours, 30 days, etc.). Favordrop 5 may comprise a data structure that may be stored in electronic form on a non-transitory computer-readable storage device in electronic communication with the processor of the administrator device. As such, favordrop 5 may be accessed by the processor at a later time, for example, if a beneficiary or another user attempts to redeem favordrop 5 for all or part of its balance. Further, if favordrop 5 is successfully redeemed in a transaction for all or part of its balance, favordrop 5's balance may be updated by the processor to reflect the cost of the transaction.

Method 100 may further comprise, at 104, assigning, using the processor, favordrop 5 to beneficiary. The processor may use the beneficiary identifier 2a to identify the beneficiary being assigned the favordrop 5. For example, when the beneficiary identifier 2a is associated with a user account recognized by the processor, the processor may assign the favordrop 5 to the beneficiary corresponding to the user account.

Method 100 may further comprise, at 105 sending, using the processor, a notification to a beneficiary device associated with the beneficiary. The notification may comprise notification data. The notification data may be at least partially displayable on a display screen of the beneficiary device. Notification may be sent to the beneficiary device by any suitable means, such as SMS, MMS, RCS, e-mail, etc. The beneficiary device may cause a push notification to display on the beneficiary device when the notification is received.

The notification data may be sent from the processor of the administrator device, via a network, to the beneficiary device. The notification data may comprise a code. The code may comprise, for example, a quick-response code, a numerical code, or an alpha-numerical code. The notification data may further comprise the balance and/or the expiration time. The notification data may further comprise identifying information of the sender (e.g., another user or a merchant) of the favordrop 5, or the notification data may be anonymous.

Method 100 may further comprise, at 106, when a current time reaches the expiration time, the processor may be configured to revoke favordrop 5 from the beneficiary and send a return notification to the user device. Similarly, the processor may be configured to assign favordrop 5 to the user or to another beneficiary after a current time reaches expiration time 2d. By assigning favordrop 5 to the user or another beneficiary, the balance 6 may return to the user or may be sent to another beneficiary to be redeemable by the buyer or another beneficiary. Alternatively, the processor may be configured to assign favordrop 5 to a merchant after a current time reaches expiration time 2d. By assigning favordrop 5 to the merchant, the balance 6 may be no longer redeemable by the beneficiary and/or the user. Instead, the balance 6 of the favordrop 5 may be applied to an account balance associated with the merchant. It should be noted that favordrop 5 may have one or more expiration times. For example, favordrop 5 may be configured such that the balance 6 is directed to a user after a first expiration time, and then directed to a merchant after a second expiration time. In this way, the user may be able to redeem the balance 6 before the favordrop 5 is assigned to the merchant and becomes no longer redeemable.

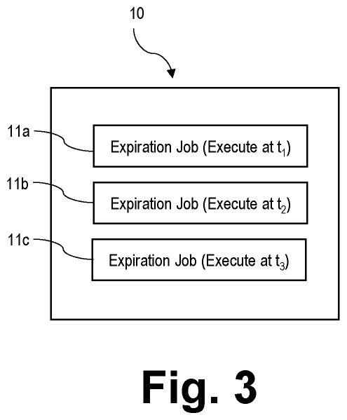

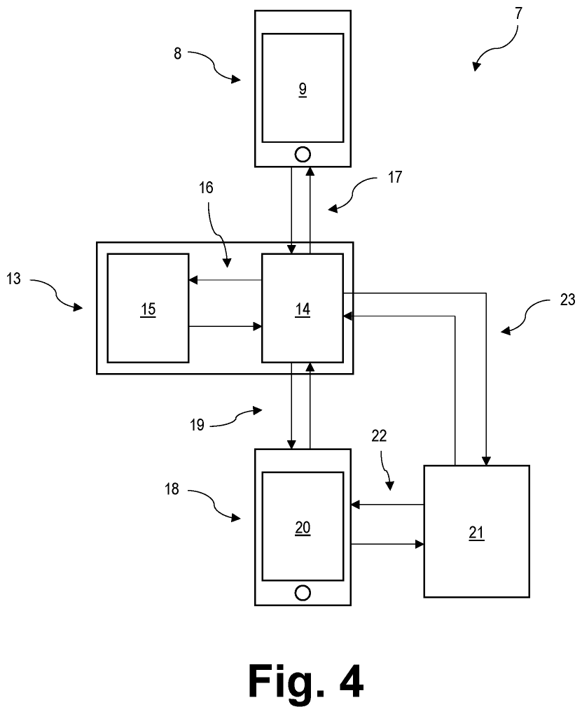

For example, favordrop 5 may be revoked from the beneficiary at an expiration time using a scheduled job in a job queue 10, such as is illustrated in FIG. 3. As depicted in FIG. 3, job queue 10 may be managed by a job scheduler. The job scheduler may be executed on the processor 14 of the administrator device 13. The job scheduler may be used to create an expiration job, for example, an expiration job 11a, scheduled to be executed at t₁, which may be expiration time 2d. Additional expiration jobs 11b and 11c similar to expiration job 11a, associated with other favordrops (or the same favordrop), may be in job queue 10 and configured to execute at t₂ and t₃, respectively. Job queue 10 may further contain other jobs set for execution by the administrator device 13.

Expiration job 11a may comprise one or more instructions, executable on the processor, to revoke favordrop 5 from the beneficiary. For example, the job scheduler may be configured to instruct the processor to execute the one or more instructions to assign favordrop 5 to a recipient (e.g., the user, another beneficiary, or the merchant) after the job scheduler determines the current time reaches expiration time 2d. Thereby, favordrop 5 may be revoked from the beneficiary once the current time reaches the expiration time 2d.

This provides improvements to current technologies in that it, for example, allows an unused portion of balance 6 of favordrop 5 to be returned to the user if not used prior to an expiration time, which may be set by the user.

In another instance, an embodiment of the present disclosure may compose a system 7, as illustrated, for example, with reference to FIG. 4. System 7 may comprise an administrator device 13 having a processor 14 and a non-transitory computer-readable storage medium 15. Processor 14 and the non-transitory computer-readable storage medium 15 may be in electronic communication via an electronic communication link 16, which may be, for example, a bus, circuit traces, or other means of electronic communication.

Administrator device 13 may be in electronic communication with a user device 8, a beneficiary device 18, and/or retailer device 21. Administrator device 13 may be in electronic communication with user device 8, for example, via electronic communication link 17. Administrator device 13 may be in electronic communication with beneficiary device 18, for example, via electronic communication link 19. Administrator device 13 may be in electronic communication with retailer device 21, for example, via electronic communication link 23.

Any or all of electronic communication links 17, 19, 22, and/or 23 may comprise a wired or wireless electronic communication link, for example, a wireless connection via the internet or a direct connection. Electronic communication links 17, 19, 22, and/or 23 may be configured so as to allow the transmission of data between respective devices.

User device 8 may be a cell phone, a laptop computer, a notebook computer, a netbook computer, a tablet, or a smart phone. User device 8 may comprise a display screen 9, which may be configured to display information.

Beneficiary device 18 may be a cell phone, a laptop computer, a notebook computer, a netbook computer, a tablet, or a smart phone. Beneficiary device 18 may comprise a display screen 20, which may be configured to display information.

Display screen 9 and/or display screen 20 may comprise, for example, a liquid-crystal display (LCD) panel, a light-emitting diode (LED) panel, or an Active Matrix Organic Light Emitting Diode (AMOLED) panel.

Processor 14 may be configured to, for example, execute one or more of the steps of method 100.

Processor 14 may be configured to receive, from buyer device 8, via electronic communication link 17, a favordrop request created at buyer device 8. The favordrop request may include a beneficiary, a request value, a retailer location, an expiration time, and a payment request.

Processor 14 may be further configured to verify, using the payment request that a payment transaction for the request value has successfully completed, thereby yielding a balance equal to the request value.

Processor 14 may be further configured to define a favordrop comprising the balance.

Processor 14 may be further configured to assign the favordrop to the beneficiary.

Processor 14 may be further configured to send a notification to the beneficiary device 18 associated with the beneficiary identifier via electronic communication link 19, the notification comprising notification data, wherein notification data is at least partially displayable on display screen 20 of beneficiary device 18.

A retailer may have a retailer device 21 configured to receive a code directly or indirectly from the notification data displayed on the beneficiary device 18 via the electronic communication link 22. The favordrop may be configured such that its balance is only redeemable at one retailer or it may be configured such that its balance is redeemable at multiple retailers. The favordrop may be configured for one-time use, regardless of balance and cost, or it may be configured such that the cost of a purchase at a retailer is subtracted from its balance and thus may be used until the balance is fully depleted. The balance of the favordrop may be reloadable by the user, the administrator, the retailer, or the beneficiary.

In some situations, a merchant or the administrator may be the user who sends the favordrop to the beneficiary. For example, the user device 8 and the retailer device 21 may be the same device associated with the merchant, or may be separate devices associated with the merchant.

The retailer device 21 may include a means to receive a code from the notification data. The code may be, for example, a quick-response (QR) code, a numerical code, or an alphanumerical code. For example, the retailer device 21 may include a scanning device configured to scan a code to determine the identifier of the favordrop the presenter of the beneficiary device 18 is seeking to use. The retailer device 21 may then communicate with administrator device 13 via, for example, electronic communication link 23, to validate the favordrop and determine what the balance is. If the retailer determines to execute a transaction using any balance on the favordrop for a cost, the retailer may then send the cost to administrator device 13 via, for example, electronic communication link 23, and processor 14 of administrator device 13 may update the balance of the favordrop stored on electronic data storage unit 15 to reflect the cost of the transaction received from retailer device 21.

Processor 14, administrator device 13 other system(s), or other subsystem(s) described herein may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

Processor 14 and an electronic data storage unit 15 may be disposed in or otherwise part of administrator device 13 or another device. In an example, the processor 14 and electronic data storage unit 15 may be part of a standalone control unit or in a centralized unit. Multiple processors or electronic data storage units may be used.

Processor 14 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 14 to implement various methods and functions may be stored in readable storage media, such as a memory in the electronic data storage unit 15 or other memory.

If administrator device 13 includes more than one computer subsystem, then the different subsystems may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

Processor 14 may be configured to perform a number of functions using the output of the system or other output. For instance, the processor may be configured to send the output to an electronic data storage unit or another storage medium. The processor may be further configured as described herein.

Processor 14 may be in communication with and/or include a memory. The memory can be, for example, a Random-Access Memory (RAM) (e.g., a dynamic RAM, a static RAM), a flash memory, a removable memory, and/or so forth. In some instances, instructions associated with performing the operations described herein (e.g., method 100) can be stored within the memory and/or a storage medium (which, in some embodiments, includes a database in which the instructions are stored) and the instructions are executed at the processor 14.

In some instances, processor 14 includes one or more modules and/or components. Each module/component executed by the processor can be any combination of hardware-based module/component (e.g., a field-programmable gate array (FPGA), an application specific integrated circuit (ASIC), a digital signal processor (DSP)), software-based module (e.g., a module of computer code stored in the memory and/or in the database, and/or executed at the processor), and/or a combination of hardware- and software-based modules. Each module/component executed by the processor is capable of performing one or more specific functions/operations as described herein. In some instances, the modules/components included and executed in the processor can be, for example, a process, application, virtual machine, and/or some other hardware or software module/component. The processor 14 can be any suitable processor configured to run and/or execute those modules/components. The processor 14 can be any suitable processing device configured to run and/or execute a set of instructions or code. For example, the processor 14 can be a general purpose processor, a central processing unit (CPU), an accelerated processing unit (APU), a field-programmable gate array (FPGA), an application specific integrated circuit (ASIC), a digital signal processor (DSP), and/or the like.

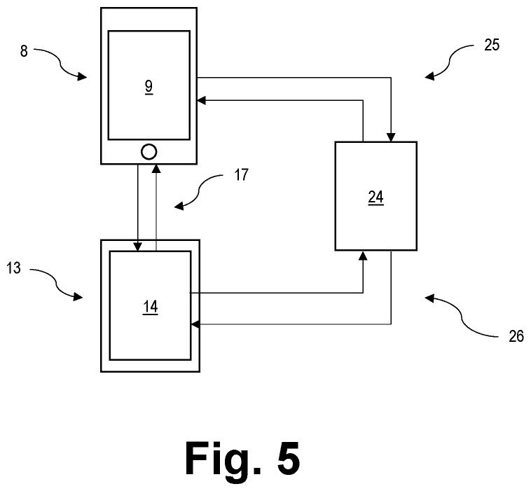

FIG. 5 illustrates an example payment processing subsystem configured to interface with processor 14.

Verifying the payment transaction may comprise receiving a confirmation from a third-party payment processor, for example, third-party payment processor 24, indicating the payment transaction using the payment data has successfully completed.

In some embodiments, the payment transaction may occur using a third-party payment processor such as third-party payment processor 24. Third party payment processor 24 may be in electronic communication with user device 8 and/or processor 14 of administrator device 13 via, for example, electronic communication links 25 and 26, respectively. In such embodiments, the user may submit certain information including transaction information (e.g., credit card or virtual payment information) to a third-party payment processor 24 for the execution of a payment transaction valued at the request value (such a value may include any transaction fees). The third-party payment processor 24 may attempt to execute a payment transaction for the request value, and send a payment transaction status to the user device 8, the administrator device 13, or both. The payment transaction status may include information regarding the success or failure of the attempted payment transaction. For example, if a payment transaction succeeds, in some embodiments the third-party payment processor 24 may provide a status to the processor 14 of the administrator device 13, verifying that the payment transaction successfully completed. In another example, in some embodiments the third-party payment processor 24 may provide a status to the user device 8, which may be, for example, tokenized or encrypted, which the user device 8 may then pass to the processor 14 of the administrator device 13. In these examples, the processor 14 of the administrator device 13 can verify the payment transaction by determining whether the received status of the payment transaction includes an indication that the payment transaction successfully completed. User device 8 may be configured to display a representation of the success or failure of the payment transaction on, for example, display screen 9.

In some embodiments, the payment transaction may be performed by the administrator, for example using administrator device 13. In such embodiments, administrator device 13 may receive certain information including transaction information (e.g., credit card or virtual payment information) via, for example, electronic communication link 17, for execution of a payment transaction valued at the request value. The administrator device 13 may attempt to execute a payment transaction for the request value, and whether the payment transaction succeeds or fails may provide verification to the processor 14. For example, processor 14 of administrator device 13 can verify the payment transaction by determining whether the attempted payment transaction succeeded or failed. User device 8 may be configured to display a representation of the success or failure of the payment transaction on, for example, display screen 9 using such status as received from processor 14 of administrator device 13.

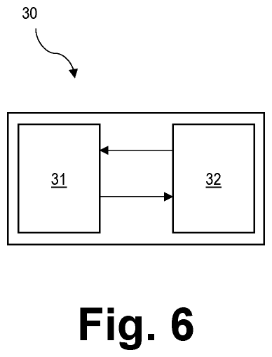

In another instance, with reference to FIG. 6, a tangible, non-transient, computer-readable media 31 may have instructions thereupon which when implemented by a processor 32 cause the processor 32 to perform one or more of the steps of method 100. Tangible, non-transient, computer-readable media 31 may comprise tangible, non-transient, computer-readable media, such as, for example, a hard disk, solid state hard drive, flash memory, memory card, universal serial bus (USB) flash memory drive, or other non-transient means of storing instructions implementable by a processor such as processor 32.

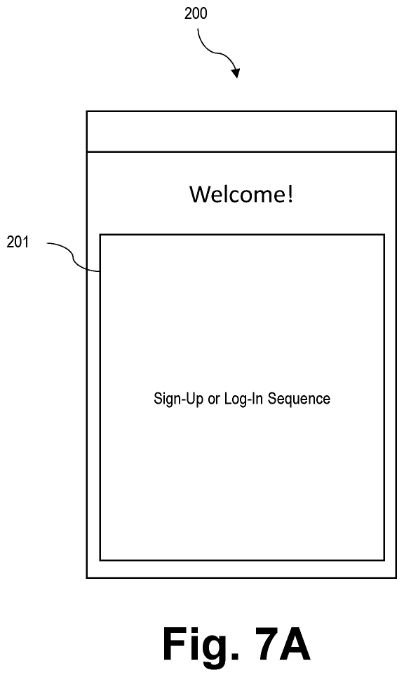

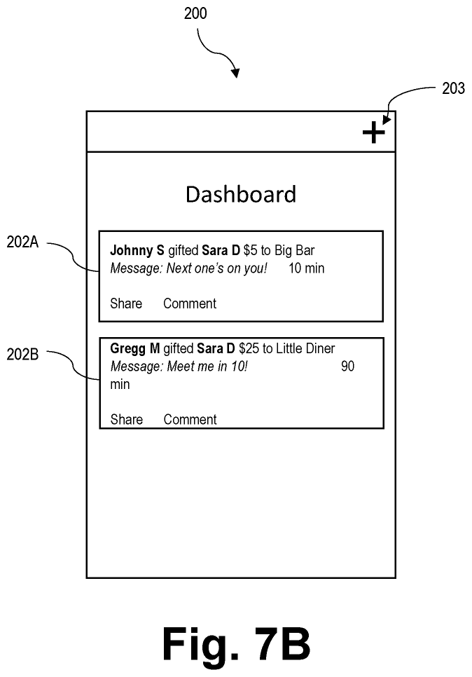

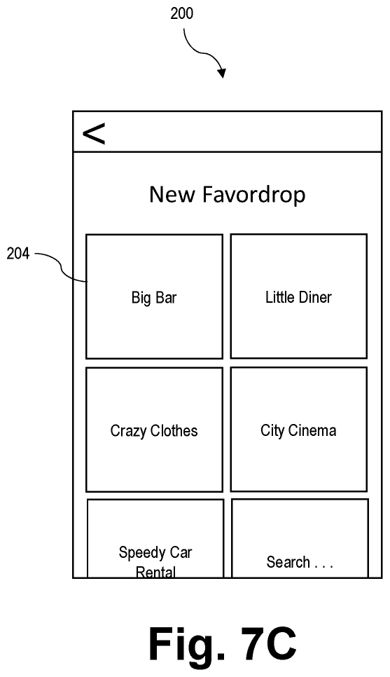

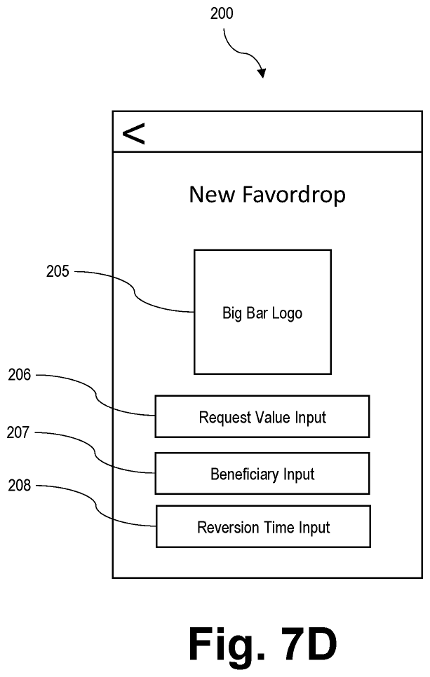

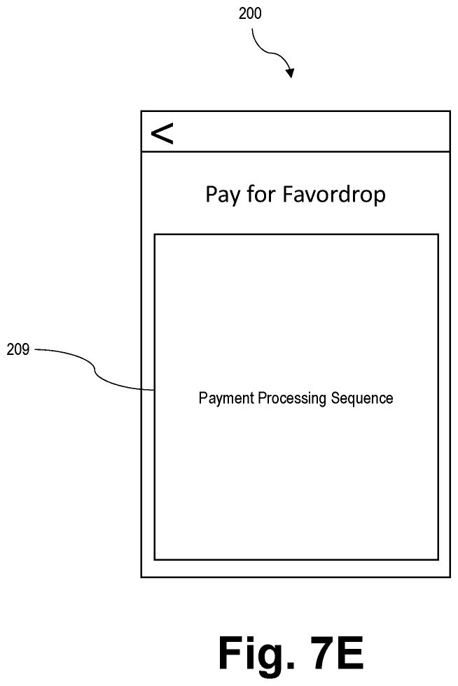

With reference to FIGS. 7A-7E, a non-limiting example illustrates an example buyer user interface, which may, for example, be an interface with embodiments of the present disclosure. The buyer user interface may be accessible via an application installed on the user device or via a web browser of the user device.

FIG. 7A illustrates an example welcome screen, as may be presented on a display screen 200 of a device of either a user or a beneficiary seeking to access functions of the temporary voucher sharing systems of the present disclosure. A user or a beneficiary may proceed through a sign-up or log-in sequence 201.

FIG. 7B illustrates an example dashboard, as may be presented on a display screen 200 of a device of either a user or a beneficiary. The dashboard may include various favordrops, such as favordrop 202A and favordrop 202B. The display screen 200 may display information corresponding to favordrop 202A and 202B. Using favordrop 202A illustrated in FIG. 7B as an example, the display screen may display one or more items of information corresponding to the favordrop 202A including: buyer information (Johnny S), beneficiary information (Sara D), balance information ($5), retailer location information (Big Bar), and/or expiration information (10 mins). The display screen 200 may also display a message from the buyer corresponding to the favordrop 202A or 202B. While the display screen 200 may display all of the above-identified information corresponding to the favordrop 202A or 202B (as illustrated in FIG. 7B), the display screen 200 may only display some of the information corresponding to the favordrop (e.g., the balance, the retailer, and/or the expiration time) as a summary, and the user may interact with the display screen (e.g., click, swipe, slide, and/or long press) to display any additional information corresponding to the favordrop (e.g., buyer information, beneficiary information, and/or a message). The dashboard may include a virtual button 203 to initiate creation of a new favordrop request. While the virtual button 203 is illustrated as a “+” (plus sign) in the top right corner of the dashboard illustrated in FIG. 7B, other types of virtual buttons (defined by various shapes and/or text) placed elsewhere in the dashboard are considered to be within the scope of the present disclosure.

FIG. 7C illustrates an example step in creating a favordrop request. For example, after selecting the virtual button 203 on the display screen 200 illustrated in FIG. 7B, the display screen 200 may change to display content shown, for example, in FIG. 7C. In FIG. 7C, display screen 200 depicts various options presented to a user, such as, for example, option 204, for selection as a retailer of the favordrop to be created. The options 204 may correspond to popular retailers, nearby retailers, recently used retailers, or most frequently used retailers. A plurality of options 204 may be displayed on the display screen 200. Additional options 204 not currently displayed on the display screen 200 may be depicted when the user clicks, scrolls, swipes, or otherwise interacts with the display screen 200. The number of options 204 displayed on the display screen 200 may depend on the size of the display screen 200. Options 204 may include a search button, through which a user may input a search string to search for a particular retailer or type of retailer. After inputting the search string, the display 200 may depict options 204 related to the search string.

FIG. 7D illustrates a further example step in creating a favordrop request. For example, the display screen 200 illustrated in FIG. 7D may be displayed after selecting a retailer (e.g., from the interface shown in FIG. 7C). The display screen 200 may depict an indicator 205 of the retailer selected by the user. For example, the indicator 205 may be a logo or the name of the retailer. The user may be presented with a request value input 206 for inputting a request value of the favordrop. The user may freely input a dollar amount in the request value input 206, or may select a dollar amount from a list of selectable options. The request value may correspond to the price of an item provided for sale by the retailer. The user may be further presented with a beneficiary input 207 for inputting the intended beneficiary of the favordrop. The intended beneficiary may be selected from a contact list provided on the user device or associated with the user account of the temporary voucher sharing system. The user may also freely input information corresponding to the intended beneficiary (e.g., name, username, phone number, e-mail address, etc.) into the beneficiary input 207. The system may then identify an account associated with the information input into the beneficiary input 207, or send a request to intended beneficiary (e.g., by phone number, e-mail address, etc.) to create an account with the temporary voucher sharing system. The user may be further presented with an expiration time input 208 for inputting an intended duration after which ownership of the favordrop may revert to the user. Alternatively, expiration time input 208 may be for inputting an intended time at which ownership of the favordrop may revert to the user. The user may freely input a time or duration in the expiration time input 208, or may select from one or more selectable options. The expiration time input 208 may also be set as a default by the system and/or the retailer. The system and/or the retailer may further impose limits on the expiration time input 208 (e.g., minimum or maximum durations, time of day limitations, etc.) or provide an additional expiration time at which any remaining balance of the favordrop is no longer redeemable.

The user may select one or more intended beneficiaries of a single favordrop. In such embodiments, the user is presented with display interfaces similar to those illustrated in FIG. 7D, through which the user may input information to assign any remaining balance of the favordrop to additional beneficiaries if a balance remains at each expiration time input by the user before returning to the buyer.

FIG. 7E illustrates a further example step in creating a favordrop request. Display screen 200 presents a payment processing sequence 209 for collecting payment data to include in a payment request. Particular details relating to the payment processing sequence are described with respect to method 100 above and are not repeated here. It should be understood that the payment processing sequence 209 may only be presented when the user is an individual who purchases a favordrop. For example, it may not be necessary to present the payment processing sequence 209 to the user when the user is a merchant sending a favordrop for use at its own retail establishment because no purchase may be processed.

With the retailer, the request value, the beneficiary, and payment request completed, the user's device may send the same as a favordrop request to the administrator device, which may perform one or more of the steps of method 100.

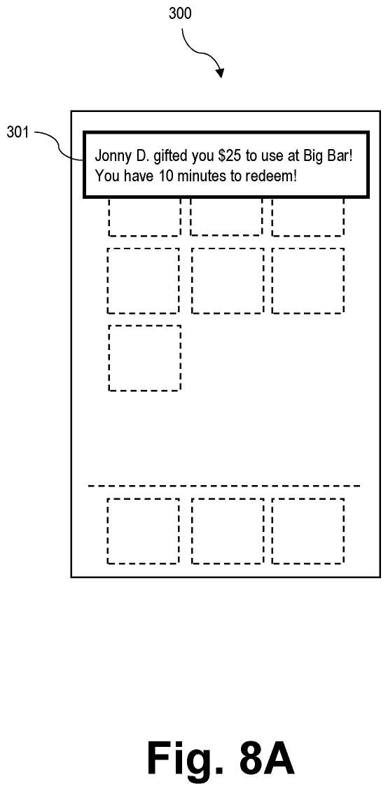

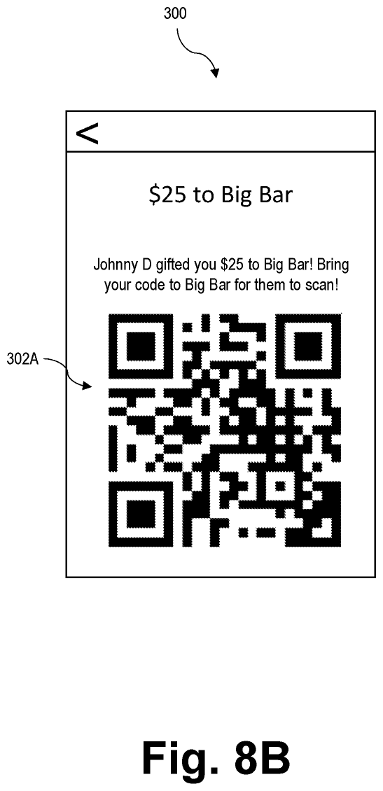

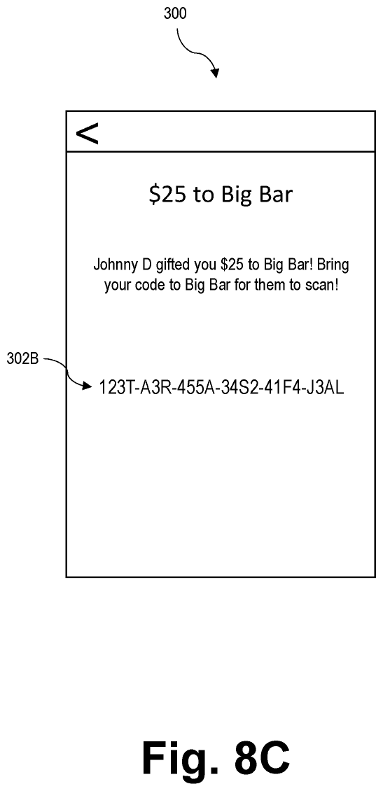

With reference to FIGS. 8A-8C, a non-limiting example illustrates an example beneficiary user interface, which may, for example, be an interface with embodiments of the present disclosure.

FIG. 8A illustrates an example display screen 300 of a beneficiary device, for example, navigated to a home screen of the beneficiary device, having a notification display 301 displayed thereon. The notification may comprise a code, the balance, and the expiration time. Notification display 301 may display one or more of the code, the balance, and the expiration time. The code may comprise, for example, a quick-response code, a numerical code, or an alpha-numerical code. The notification may comprise, for example, an e-mail, an SMS message, or a push notification. The beneficiary may select the notification display 301 to open/view additional details of the notification. If an application corresponding to the temporary voucher sharing system is installed on the beneficiary device, selecting the notification display 301 may open the application and view the notification. Alternatively, selecting the notification display 301 may open a web browser, SMS message application, or e-mail application of the beneficiary device to view additional details of the notification.

FIG. 8B illustrates an example display screen 300 of a beneficiary device, depicting notification data of the notification. For example, a QR code 302A, representing the code, may be displayed. Alternatively, as illustrated for example in FIG. 8C, an alpha-numerical code may be displayed. The notification data of the notification may also comprise sender information and retailer information.

A retailer or merchant may have access to a retailer interface in electronic communication with the administrator device, the retailer interface may be configured to provide means for the retailer to scan or input a code or other notification data, verify a balance of a favordrop, issue and/or modify favordrops (e.g., those associated with the retailer), submit transactions to the administrator device, or other functions dealing with the administration or maintenance of favordrops associated with the retailer. The retailer interface may be configured to provide means for sending a favordrop to a beneficiary, redeemable at a retailer location associated with the retailer/merchant, similar to the user interface described above and illustrated in FIGS. 7A-7E. The retailer or merchant may pay a subscription fee to access the retailer interface and to perform one or more of the functions described above.

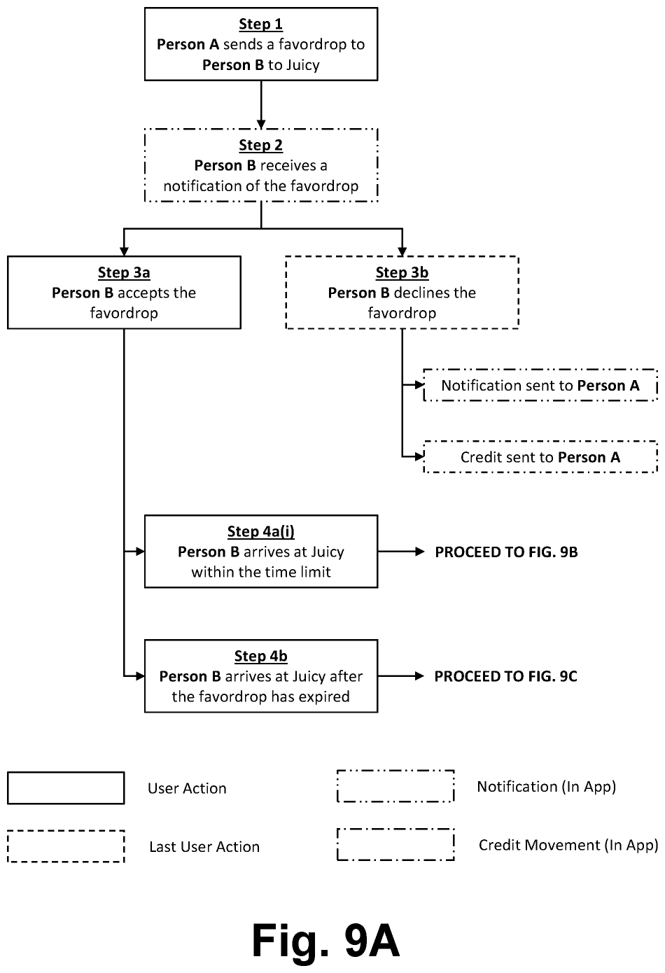

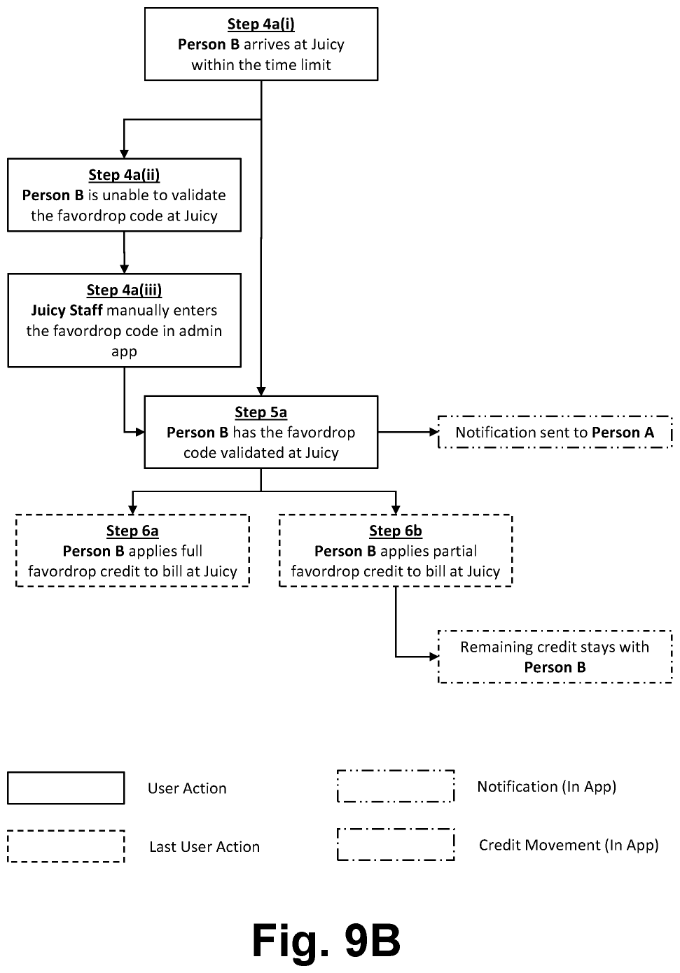

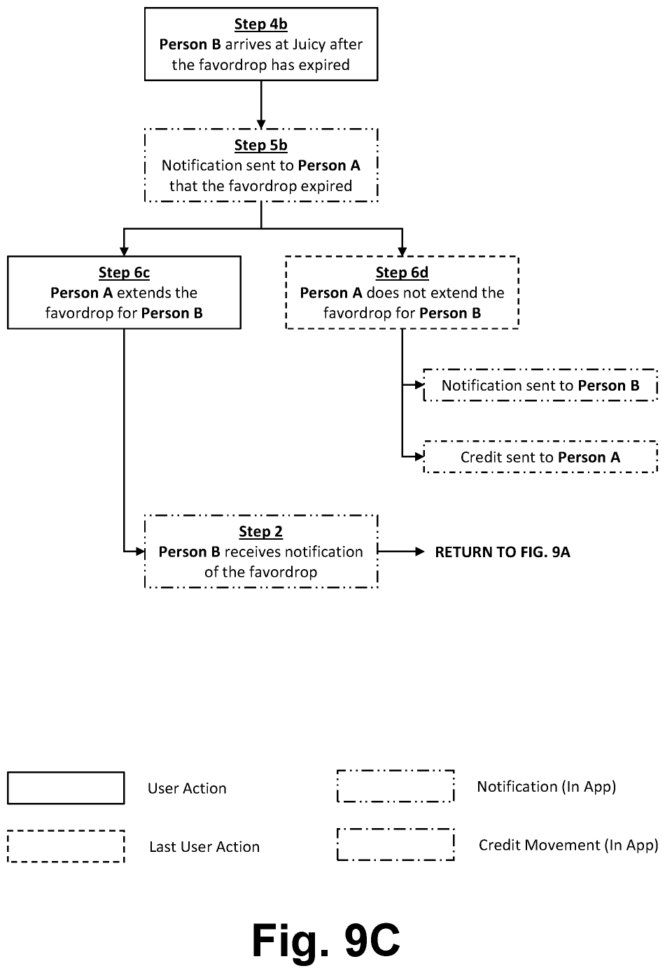

FIGS. 9A-9C illustrate an example flowchart of a method of temporary voucher sharing according to embodiments of the present disclosure. The method may comprise the following steps.

Referring to FIG. 9A, at step 1, Person A sends a favordrop to Person B at a retailer called “Juicy.”

At step 2, Person B receives a notification of the favordrop received from Person A. Upon receipt, Person B may accept or decline the favordrop.

At step 3b, Person B declines the favordrop. A notification is sent to Person A indicating the decline, and a credit is sent to Person A.

At step 3a, Person B accepts the favordrop. After accepting the favordrop, Person B needs to use the favordrop before its stated time limit, for example, by arriving at Juicy.

At step 4a(i), Person B arrives at Juicy within the stated time limit. Person B then shows the favordrop information to Juicy staff when making a purchase. Referring to FIG. 9B, if the Juicy staff is unable to validate the favordrop information from the code presented by Person B (at step 4a(ii)), the Juicy staff may manually enter the favordrop code into an admin app (at step 4a(iii)). The Juicy staff may validate the favordrop code (either as first presented in step 4a(i) or manually entered at step 4a(iii)) at step 5a. A notification may be sent to Person A indicating that Person B has used the favordrop. Person B may then complete a purchase at Juicy using the favordrop.

At step 6a, Person B applies the full favordrop credit to the bill at Juicy.

Alternatively, at step 6b, Person B applies partial favordrop credit to the bill at Juicy. The balance of the favordrop credit may be updated based on the amount used for the purchase.

Referring to FIG. 9C, if Person B arrives at Juicy after the stated time limit (at step 4b), Person A receives a notification (at step 5b) that Person B missed the deadline. Upon receipt of the notification Person A may choose to extend the time limit or not.

At step 6c, Person A extends the time limit of the favordrop to Person B. Then, the method proceeds to step 2 (returning to FIG. 9A).

Alternatively, at step 6d, Person A does not extend the time limit of the favordrop to Person B. Then, a notification is sent to Person B, and the credit is sent to Person A.

According to the method shown in FIGS. 9A-9C, Person A may temporarily share a voucher with Person B for use at a particular retailer, and if Person B fails to use some or all of the voucher before the stated time limit, the balance of the voucher returns to Person A who may redeem the voucher at the retailer.

Additional examples of user interfaces and methods of temporary voucher sharing are provided in an appendix of U.S. Provisional Application No. 63/089,581, the entire disclosure of which is incorporated by reference herein.

The steps of the method described in the various embodiments and examples disclosed herein are sufficient to carry out the methods of the present invention. Thus, in an embodiment, the method consists essentially of a combination of the steps of the methods disclosed herein. In another embodiment, the method consists of such steps.

Although the present disclosure has been described with respect to one or more particular embodiments, it will be understood that other embodiments of the present disclosure may be made without departing from the scope of the present disclosure.

Hence, the present disclosure is deemed limited only by the appended claims and the reasonable interpretation thereof.

1. A method of temporary voucher sharing, comprising:
receiving, from a user device associated with a user, at a processor of an administrator device, a favordrop request created at the user device, the favordrop request including a beneficiary identifier associated with a beneficiary, a request value, a retailer location, and an expiration time;
defining, using the processor, a favordrop comprising a balance corresponding to the request value;
assigning, using the processor, the favordrop to the beneficiary;
sending, using the processor, a notification to a beneficiary device associated with the beneficiary identifier, the notification comprising notification data, wherein the notification data is at least partially displayable on a display screen of the beneficiary device; and
when a current time reaches the expiration time, the processor is configured to:
revoke the favordrop from the beneficiary; and
send a return notification to the user device.

2. The method of claim 1, wherein the user is a merchant, the user device is a merchant device associated with the retailer location, and when the current time reaches the expiration time, the processor is further configured to:
apply the balance of the favordrop to an account balance of the merchant.

3. The method of claim 1, further comprising:
verifying, using the processor, that a payment transaction for the request value has successfully completed using a payment request initiated by the user device and thereafter defining the balance as being equal to the request value; and
when the current time reaches the expiration time, the processor is further configured to:
assign the favordrop to the user;
wherein the notification data is at least partially displayable on a display screen of the user device and the return notification comprises the notification data.

4. The method of claim 3, wherein verifying that the payment transaction for the request value has successfully completed comprises:
receiving a confirmation from a third-party payment processor indicating that the payment transaction has successfully completed.

5. The method of claim 1, further comprising:
creating, using a job scheduler executed by the processor, an expiration job in a job queue managed by the job scheduler, wherein the expiration job comprises one or more instructions, executable by the processor, to revoke the favordrop from the beneficiary;
wherein the job scheduler is configured to instruct the processor to execute the one or more instructions of the expiration job after the job scheduler determines that the current time reaches the expiration time, thereby revoking the favordrop from the beneficiary when the current time reaches the expiration time.

6. The method of claim 1, further comprising:
receiving, from a retailer device associated with the retailer location, at the processor, a redemption notification that the favordrop was applied as a payment for a purchase at the retailer location; and
updating, using the processor, the balance based on a portion of the favordrop applied as the payment for the purchase at the retailer location.

7. The method of claim 1, wherein the notification data comprises a code, which, when input by a retailer device associated with the retailer location, applies the balance of the favordrop as a payment for a purchase at the retailer location.

8. The method of claim 7, wherein the code comprises a quick-response code, a numerical code, or an alpha-numerical code.

9. The method of claim 1, wherein the notification data comprises the balance and the expiration time.

10. A system for temporary voucher sharing, comprising:
an administrator device having a processor configured to:
receive, from a user device associated with a user, a favordrop request created at the user device, the favordrop request including a beneficiary identifier associated with a beneficiary, a request value, a retailer location, and an expiration time;
define a favordrop comprising a balance corresponding to the request value;
assign the favordrop to the beneficiary;
send a notification to a beneficiary device associated with the beneficiary identifier, the notification comprising notification data, wherein the notification data is at least partially displayable on a display screen of the beneficiary device; and
when a current time reaches the expiration time, the processor is further configured to:
revoke the favordrop from the beneficiary; and
send a return notification to the user device.

11. The system of claim 10, wherein the user is a merchant, the user device is a merchant device associated with the retailer location, and when the current time reaches the expiration time, the processor is further configured to:
apply the balance of the favordrop to an account balance of the merchant.

12. The system of claim 10, wherein the processor is further configured to:
verify that a payment transaction for the request value has successfully completed using a payment request initiated by the user device and thereafter defining the balance as being equal to the request value; and
when the current time reaches the expiration time, the processor is further configured to:
assign the favordrop to the user;
wherein the notification data is at least partially displayable on a display screen of the user device and the return notification comprises the notification data.

13. The system of claim 12, wherein the processor is configured to verify that the payment transaction for the request value has successfully completed by:
receiving a confirmation from a third-party payment processor indicating that the payment transaction has successfully completed.

14. The system of claim 10, wherein the processor is further configured to:
create, using a job scheduler executed by the processor, an expiration job in a job queue managed by the job scheduler, wherein the expiration job comprises one or more instructions, executable by the processor, to revoke the favordrop from the user;
wherein the job scheduler is configured to instruct the processor to execute the one or more instructions of the expiration job after the job scheduler determines that the current time reaches the expiration time, thereby revoking the favordrop from the beneficiary when the current time reaches the expiration time.

15. The system of claim 10, wherein the processor is further configured to:
receive, from a retailer device associated with the retailer location, a redemption notification that the favordrop was applied as a payment for a purchase at the retailer location; and
update the balance based on a portion of the favordrop applied as the payment for the purchase at the retailer location.

16. The system of claim 10, wherein the notification data comprises a code, which, when input by a retailer device associated with the retailer location, applies the balance of the favordrop as a payment for a purchase at the retailer location.

17. The system of claim 16, wherein the code comprises a quick-response code, a numerical code, or an alpha-numerical code.

18. The system of claim 10, wherein the notification data comprises the balance and the expiration time.

19. A tangible, non-transient, computer-readable media having instructions thereupon which, when implemented by a processor, causes the processor to perform a method of temporary voucher sharing comprising:
receiving, from a user device associated with a user, at the processor, a favordrop request created at the user device, the favordrop request including a beneficiary identifier associated with a beneficiary, a request value, a retailer location, and an expiration time;
defining a favordrop comprising a balance corresponding to the request value;
assigning the favordrop to the beneficiary;
sending a notification to a beneficiary device associated with the beneficiary identifier, the notification comprising notification data, wherein the notification data is at least partially displayable on a display screen of the beneficiary device; and
when a current time reaches the expiration time, the processor is configured to:
revoke the favordrop from the beneficiary; and
send a return notification to the user device.
